(19) United States
(12) Patent Application Publication
(10) Pub. No.: US 2026/0298001 A1
(43) Pub. Date: Oct. 1, 2026

(54) HINGE ASSEMBLY AND DOOR SYSTEM

(71) Applicant: Kingsway Enterprises (UK) Limited, Sidcup (GB)

(72) Inventors: Benjamin Hall, Sidcup (GB); Melvyn French, Sidcup (GB)

(21) Appl. No.: 19/483,323

(22) PCT Filed: Mar. 19, 2024
(86) PCT No.: PCT/GB2024/050738

§ 371 Date: Nov. 11, 2025

(30) Foreign Application Priority Data
May 12, 2023 (GB) 2307102.0

(51) Int. Cl. E05D 7/081; E05D 3/02; E05D 7/00; E05D 11/00

(52) U.S. Cl. CPC E05D 7/081; E05D 3/02; E05D 7/009; E05D 11/0054; E05Y 2201/628; E05Y 2900/132

(57) ABSTRACT

The present disclosure relates to a hinge assembly. The hinge assembly comprising: an elongate hinge pin for attachment to a door leaf; an end-cap for attachment to a wall or door frame, wherein an end of the hinge pin is rotatably received within the end-cap; and an elongate outer casing surrounding the hinge pin, wherein the outer casing has an inner surface which receives the hinge pin, and a cylindrical outer surface which is radially spaced from the inner surface.

### RELATED APPLICATIONS

The present application is a national stage application under 35 U.S.C. § 371 of International Application No. PCT/GB2024/050738, filed Mar. 19, 2024, which claims priority to Great Britain Patent Application No. 2307102.0 filed May 12, 2023. The above-referenced applications are hereby incorporated by reference into the present application in their entirety.

### FIELD

The present disclosure relates to a hinge assembly, to a door system incorporating the hinge assembly, and in particular to a hinge assembly and corresponding door system arranged to eliminate ligature points.

### BACKGROUND

In psychiatric hospitals and prisons, a problem exists that patients and inmates may wish to cause themselves harm using a ligature created by securing a rope or cable around an available anchor point in a room. One solution to this problem is to design room fixtures and fittings such that they do not provide such anchor points. Many bespoke fixtures and fittings exist for psychiatric hospitals and prisons, with this aim in mind. However, suicides in psychiatric hospitals and prisons remain a problem. Patients and inmates continue to find anchor points from which to secure a ligature and cause themselves harm.

One particular problem area is door systems. By design, door systems include hinges which necessarily include moving parts. These moving parts are a high-risk area for ligatures, because they can be used to create pinch points from which ligatures can be anchored. Accordingly, there is a demand for hinges which remove or eliminate ligature pinch points.

### SUMMARY

The present disclosure has been developed to address at least some of the problems noted above.

In a first aspect there is provided a hinge assembly comprising:
an elongate hinge pin for attachment to a door leaf;
an end-cap for attachment to a wall or door frame, wherein an end of the hinge pin is rotatably received within the end-cap; and
an elongate outer casing surrounding the hinge pin, wherein the outer casing has an inner surface which receives the hinge pin, and a cylindrical outer surface which is radially spaced from the inner surface.

The inventors have found that the outer casing provides a number of distinct advantages over previous door systems. Firstly, the outer casing shrouds the elongate hinge pin, thereby concealing any ligature points or otherwise potentially harmful features (such as sharp protrusions or indentations) along the hinge pin. Secondly, by employing an outer casing having a greater outer diameter than that of the hinge pin, the mechanics of the hinge are shielded behind the outer surface of the outer casing. In particular, the mechanics of the hinge (namely, the interaction between the hinge pin and the end-cap), which would otherwise present problematic ligature points, are concealed behind the outer surface of the outer casing. Additionally, the outer casing may also increase the outer diameter of the hinge assembly sufficiently to eliminate potential pinch points between a door leaf and a door frame or wall to which the door leaf is attached. This is illustrated in FIGS. 1 and 2 below.

The hinge pin may be cylindrical at least at each end thereof. In some examples, the hinge pin is cylindrical along its entire length, and may be of uniform diameter along its entire length. The inner surface of the outer casing may have a cross-section which matches that of the hinge pin (e.g. both in shape and diameter), such that the hinge pin is a snug fit in the outer casing. That is, where the hinge pin is cylindrical along its entire length, the inner surface of the elongate outer casing may similarly be cylindrical, having a diameter which substantially matches that of the hinge pin.

The end-cap may comprise a recess, for example a cylindrical recess, configured to receive the end of the hinge pin. The cylindrical recess may have a diameter which substantially matches that of the hinge pin (e.g. that matches that of the end of the hinge pin), or is marginally larger than that of the hinge pin so as to support rotation of the hinge pin therein.

An end of the outer casing, for example an end of the outer casing adjacent the end of the hinge pin, may engage the end-cap. In some examples, the end of the outer casing may terminate adjacent an opening in the end-cap, for example may abut the opening in the end-cap. The outer surface of the outer casing may have a diameter which substantially matches an outer diameter of the end-cap. The end-cap and the outer casing may form a substantially continuous outer surface which conceals the hinge pin. The outer surface may be exposed.

The hinge assembly may further comprise an elongate backplate for attachment to a wall or door frame. The backplate may be substantially the same length as the outer casing. The backplate may have an elongate channel. The end-cap may abut an end of the backplate. The outer casing may be received by the channel. For example, the channel may engage the outer surface of the outer casing.

The channel may have a width which spans no more than a 18020 arc of the outer casing. Therefore, at least a 180° arc of the outer casing may be exposed.

The channel may have a curvature which substantially matches that of the outer surface of the outer casing. Accordingly, the outer casing may intimately engage the channel, with substantially no gaps therebetween. Accordingly, there may be no ligature points between the outer casing and the backplate.

The backplate may comprise two shoulder surfaces, each of which slopes away from a respective outer edge of the channel. The outer casing may abut an intersection between each shoulder and the channel. The outer casing may be received by the channel such that substantially no gaps exist between the outer casing and the intersections. Accordingly, there may be no ligature points between the outer casing and the backplate.

The hinge pin may comprise a solid rod, for example a solid metal rod, for example a solid aluminium rod. The hinge pin may comprise an elongate groove formed therein. The elongate groove may be formed along the hinge pin, for receiving a door leaf therein.

A friction-reducing disc may be attached to the end of the hinge pin, for example to each end of the hinge pin, wherein the/each friction-reducing disc has a lower coefficient of friction than the surface of the hinge pin. The disc may have a surface formed of a low-friction material, for example Polytetrafluoroethylene (PTFE), such as Teflon, or Nylon. In some examples, the disc may be formed of the low-friction material.

The outer casing may comprise an elongate opening. The elongate opening may be formed along the outer casing. The elongate opening may be provided for receiving a door leaf. Accordingly, the door leaf may protrude from the elongate opening in the outer casing. The elongate opening may intimately engage the door leaf, such that no gaps exist between the elongate opening and door leaf. The elongate opening may be aligned with the elongate groove. The elongate opening may be at least as long as the elongate groove. The elongate opening may be substantially the same width as the elongate groove. In some examples, the elongate groove may extend the entire length of the outer casing.

The outer casing may be configured to co-rotate with the hinge pin. That is, the outer casing may have a fixed rotational orientation relative to the hinge pin. Accordingly, the outer casing may rotate in the end-cap with the hinge pin.

The outer casing may be rigid, i.e. substantially rigid. That is, it may be sufficiently rigid that it does not deform under normal operation of the hinge assembly or under compressive forces applied by a patient. It may, for example, be formed of metal, for example aluminium. However, it may alternatively be formed of a rigid plastic material, such as nylon. Accordingly, because the outer surface of the hinge assembly is made substantially rigid by the outer casing, the robustness of the hinge assembly is high. Additionally, because the outer casing does not deform, it cannot be manipulated or deformed to create a ligature point.

The outer diameter of the outer casing may be at least 3 times the width of the drove formed in the hinge pin, for example at least 5 times the width of the groove formed in the hinge pin. In some examples, the outer diameter of the outer casing may be at least 6 times the width of the groove formed in the hinge pin. For example, the outer diameter of the outer casing may be 7 times the width of the groove formed in the hinge pin. This may further help to avoid ligature points.

The outer diameter of the outer casing may be at least 50 mm, for example at least 60 mm, for example 70 mm. The outer diameter of the outer casing may be at most 100 mm. This may further help to avoid ligature points.

The outer diameter of the outer casing may be at most 10 times the width of the groove formed in the hinge pin.

The outer casing comprise an cylindrical inner wall for receiving the hinge pin, and an outer cylindrical wall which is radially spaced from the inner cylindrical wall. The outer cylindrical wall may be spaced from the inner cylindrical wall by at least one web, for example by a plurality of webs. The webs may be evenly spaced around the circumference of the outer casing.

The end of the hinge pin may protrude from a corresponding end of the outer casing.

The hinge assembly may further comprise an annular bearing attached to a/the end of the outer casing, the annular bearing being received within the end-cap to facilitate rotation of the outer casing relative to the end-cap. The annular bearing may comprise a bearing surface having a lower coefficient of friction than that of the outer surface of the outer casing. The bearing surface may engage the end-cap, for example a recess of the end-cap (e.g. second cylindrical recess of the end-cap), so as to facilitate rotation of the outer casing relative to the end-cap.

The bearing surface may comprise a low-friction material, for example Polytetrafluoroethylene (PTFE), such as Teflon, or Nylon. In some examples, the entire annular bearing may be formed of the low-friction material.

The end of the hinge pin and the annular bearing adjacent the end of the hinge pin may be received within the end-cap. The end of the hinge pin may be received within a first cylindrical recess in the end-cap; and the annular bearing may be received in a second cylindrical recess in the end-cap. The first and second cylindrical recesses may be concentric. The second cylindrical recess may be shallower than the first cylindrical recess. Accordingly, the hinge pin and the outer casing may rotate relative to the end-cap within their respective cylindrical recesses.

A protrusion may laterally extend from the first end of the hinge pin. The end-cap may comprise a circumferential track within which the protrusion is received. Each end of the circumferential track may comprise an abutment arranged to engage the protrusion to thereby restrict the rotational motion of the hinge pin. The abutments may be positioned to restrict the rotational motion of the hinge pin to less than 180°. The protrusion may comprise a bar, for example a metal bar, extending laterally from the hinge pin.

The protrusion may be adjacent to an end of the groove, and may be in-line with the groove. The protrusion may be adjacent to the annular bearing.

The circumferential track for receiving the protrusion may be formed in an end-surface of the second cylindrical recess described above.

The hinge assembly may comprise a first end cap at a first end of the hinge pin, and a second end-cap at a second end of the hinge pin. The first end of the hinge pin may be rotatably received within the first end-cap. The second end of the hinge pin may be rotatable received within the second end-cap. A first end of the outer casing (adjacent the first end of the hinge pin) may engage/abut the first end-cap. A second end of the outer casing (adjacent the second end of the hinge pin) may engage/abut the second end-cap. The first and second end-caps may abut respective ends of the backplate. The first and second end-caps may be substantially identical to one another. They may define respective ends of the hinge assembly. The end-caps may be exposed, i.e. not concealed by other components of the hinge assembly.

As the reader will understand, operation of the first end-cap at the first end of the hinge assembly, and operation of the second end-cap at the second end of the hinge assembly, may be as described above for the end-cap.

In a second aspect there is provided a door system comprising the hinge assembly according to any preceding claim, and a door leaf attached to the hinge pin. The door leaf may be received within an elongate groove of the hinge pin. The hinge assembly may be attached to a wall or door frame. For example, the end-cap(s) of the hinge assembly may be attached to a wall or door frame. The backplate may further be attached to the wall or door frame.

The door system may further comprise a flexible door jamb positioned to oppose the door leaf, and further arranged to abut the door leaf when the door leaf is in a closed position. The flexible door jamb may comprise a flexible fin.

### BRIEF DESCRIPTION OF THE DRAWINGS

Examples of the present disclosure will now be described, with reference to the accompanying drawings, in which:

FIG. 1 schematically illustrates a door system according to the prior art;

FIG. 2 schematically illustrates a door system according to the present disclosure;

FIG. 3 shows a perspective view of a door system according to the present disclosure;

FIG. 4 shows an exploded view of the door system from FIG. 3;

FIG. 5 shows an exploded view of a first end of a hinge assembly from the door system of FIGS. 3 and 4;

FIG. 6 shows an assembled view of the first end of the hinge assembly from FIG. 5;

FIG. 7 schematically illustrates a side-view of an inner structure of an end-cap from the hinge assembly of FIG. 5;

FIG. 8 shows an underside view of an end-cap from the hinge assembly of FIG. 5;

FIG. 9 shows an end-view of a backplate from the hinge assembly of FIG. 5;

FIG. 10 shows an end-view of an outer casing from the hinge assembly of FIG. 5;

FIG. 11 shows a perspective view of an annular bearing from the hinge assembly of FIG. 5;

FIG. 12 shows a cross-sectional view of a hinge pin from the hinge assembly of FIG. 5;

FIG. 13A shows a first perspective view of an end-cap according to the present disclosure;

FIG. 13B shows a side-view of an end-cap according to the present disclosure;

FIG. 13C shows a front-view of an end-cap according to the present disclosure;

FIG. 13D shows a second perspective view of an end-cap according to the present disclosure; and

FIG. 14 shows a door leaf according to the present disclosure.

Like reference numerals are used for like components throughout the description and the drawings.

### DETAILED DESCRIPTION

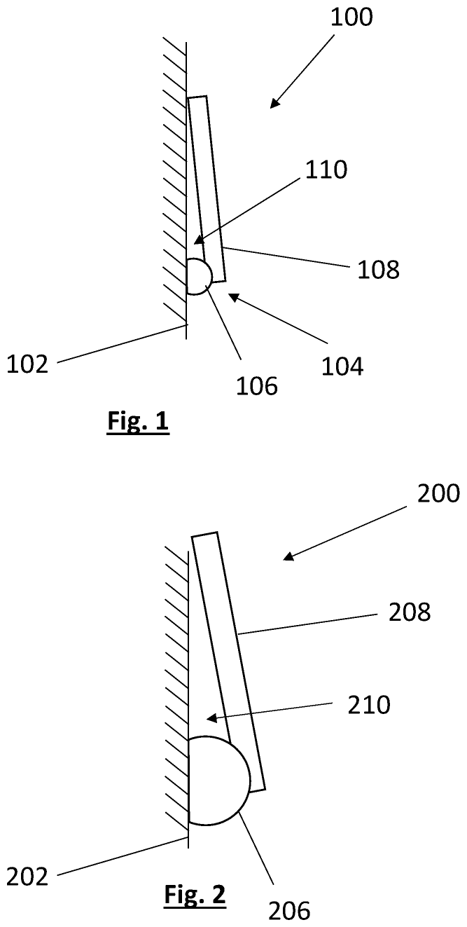

FIG. 1 shows a schematic illustration of a door system 100 according to the prior art. Shown in FIG. 1 is a wall surface 102 to which a door system 104 is attached. The door system 104 comprises a hinge assembly 106 and a door leaf 108. As can be seen, the outer diameter of the hinge assembly 106 is comparable to that of the door leaf 108. Dimensions are exaggerated slightly for illustrative purposes. In the arrangement of FIG. 1, the door system 104 is in an open configuration, with the door leaf 108 opened so that it abuts the wall to which it is attached. As illustrated, a small gap 110 exists between the door leaf 108, the hinge assembly 106, and the wall surface 102. This small gap creates a high-risk pinch point which can be used to trap a ligature, for example a ligature with a large knot tied to an end thereof. In particular, a patient could trap or wedge the knot of the ligature into the pinch point 110 between the door leaf 108, the hinge assembly 106 and the wall surface 102.

The inventors have found that by increasing an outer diameter of the hinge assembly, the size of the gap between the door leaf, the hinge assembly, and the wall surface can be increased sufficiently that the gap cannot be used to trap, wedge or anchor a ligature.

FIG. 2 illustrates a door system 200 according to the present disclosure in which the gap 210 between the door leaf 208, the hinge assembly 206 and the wall surface 202 is significantly increased by significantly increasing the outer diameter of the hinge assembly 206. The schematic illustration of FIG. 2 is not to scale, but illustrates clearly that the gap 210 is significantly larger than in the prior art arrangement of FIG. 1. By appropriately selecting the outer diameter of the hinge assembly 206 relative to the thickness of the door leaf 208, the size of the gap 210 is increased sufficiently to prevent it from being useable to anchor a ligature. In the exemplary embodiment described below, the door leaf is 10 mm in thickness, and the outer diameter of the hinge assembly is 70 mm. That is, the outer diameter of the hinge assembly is 7 times larger than the door leaf thickness. However, other thicknesses and diameters may be used as appropriate. In some arrangements, it may be sufficient for the outer diameter of the outer casing to be at least three times the thickness of the door leaf, for example at least 5 times the thickness of the door leaf.

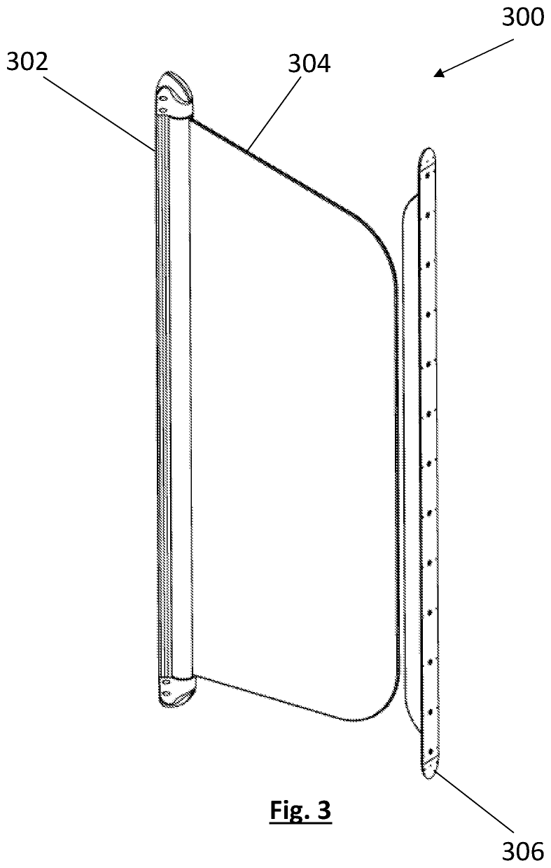

FIG. 3 shows a door system 300 according to the present disclosure. The door system 300 comprises a hinge assembly 302, a door leaf 304, and a closing edge fin 306. The door system 300 is illustrated in a closed position, in which the closing edge of the door leaf 304 (the edge distal from the hinge assembly 302) is positioned adjacent the closing edge fin 306. In some examples, the door leaf 304 may abut the closing edge fin 306. In others, a small gap, typically of a few millimetres, remains between the door leaf 304 and the flowing edge fin 306. The door leaf may comprise a plastic material, for example Acrylonitrile Butadiene Styrene (ABS). The door may, for example, be formed of the plastic material.

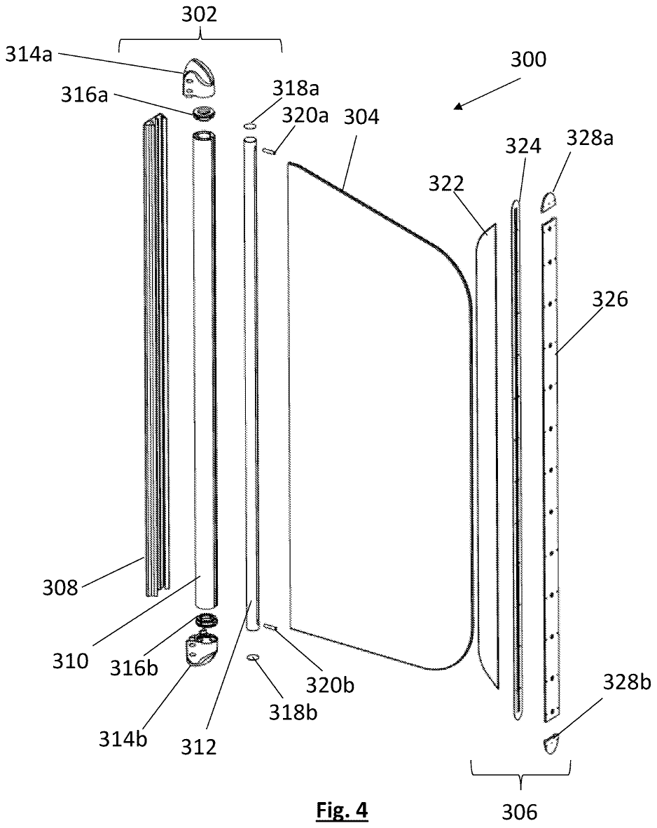

FIG. 4 shows an exploded view of the door system 300 of FIG. 3. As shown in FIG. 4, the hinge assembly 302 comprises a backplate 308, an outer casing 310, a hinge pin 312, a first (top) end-cap 314a, a second (bottom) end-cap 314b, a first (top) annular bearing 316a, a second (bottom) annular bearing 316b, a first (top) friction-reducing (e.g. PTFE-coated or Teflon-coated) disc 318a, a second (bottom) friction-reducing disc 318b, a first (top) pin 320a, and a second (bottom) pin 320b. As also shown in FIG. 4, the closing edge fin 306 comprises a fin member 322, a front plate 324, a back plate 326, a first (top) end plate 328a, and a second (bottom) end plate 328b. The fin member 322 is formed of a flexible, puncture-resistant material.

While the hinge assembly 302 is exemplified here as having both a first end-cap 314a located at the top of the hinge assembly, and a second end-cap 314b at the bottom of the hinge assembly, in some examples only a first end-cap or only a second end-cap may be provided. For example, in some examples, the first (top) end of the hinge assembly may insert straight into a ceiling, such that only the second (bottom) end cap 314b is required. Similarly, in other examples, the second (bottom) end of the hinge may insert straight into the floor, such that only the first (top) end cap 314a is required.

FIG. 5 shows an exploded view of the first (top) end of the hinge assembly 302 from FIGS. 3 and 4. As the reader will understand, in examples in which both ends of the hinge assembly 302 include an end-cap, the second (bottom) end of the hinge assembly will have the same structure as the first (top) end. While the first end-cap 314a and its interaction with the outer casing 310 and the hinge pin 312 will be described in detail, the reader will understand that the second end-cap 314b (if present) has the same structure and the same interaction with the outer casing 310 and the hinge pin 312.

As illustrated in FIG. 5, the backplate 308 includes an elongate channel 330 formed along the entire length thereof. As will become clear from the later description, the elongate channel is sized to intimately engage the outer side surface of the outer casing 310, so that no gaps exist therebetween. The outer casing 310 is configured to rotate within the channel 330, such that the intimate engagement is maintained as it rotates.

The outer casing 310 has an elongate opening 332 formed the entire length along it. The elongate opening is configured to have the same diameter as a door leaf to be received therethrough. Therefore, when assembled, the door leaf 304 protrudes from the outer casing 310, with no gaps existing between the outer casing 310 and the door leaf 304. The outer casing 310 has a cylindrical outer surface 334 and a cylindrical inner surface 336. The cylindrical outer surface 334 is spaced from the cylindrical inner surface 336 by a number of webs, which will be described in more detail later.

The hinge pin 312 is a solid cylindrical metal rod. It has an outer diameter which matches the inner diameter of the outer casing 310. Accordingly, the hinge pin 312 is a snug fit within the outer casing 310. The hinge pin includes an elongate groove 338 formed along it. The elongate groove 338 is provided to receive the door leaf 304. The elongate groove 338 therefore has a width which matches the width of the door leaf 304, and a length which matches the length (height) of the door leaf. The door leaf 304 may be secured to the hinge pin 312 by screws (not shown) extending transversely through the hinge pin 312 and the door leaf 304.

The annular bearing 316a attaches to the end of the outer casing 310 to provide a low-friction bearing surface at the end of the outer casing. The friction-reducing disc 318a attaches to the end of the hinge pin 312 to provide a low-friction surface at the end of the hinge pin 312. The pin 320a inserts into a corresponding opening 321a in the hinge pin.

When assembled, the hinge pin 312 is inserted into the outer casing 310. The end of the hinge pin 312 inserts into the end-cap 314a, and the disc 318a provides a low-friction interaction between the hinge pin 312 and the end-cap 314a. The annular bearing 316a is also inserted into the end-cap 314a, and similarly provides a low-friction interaction between the outer casing 310 and the end-cap 314a. Finally, the end-cap 314a engages the end of the backplate 308. When assembled in this way, the outer surface 334 of the outer casing 310 forms a substantially continuous surface with the outer surface of the end-cap 314a, and further forms a continuous surface with the outer surface of the backplate 308. Substantially no gaps exist between the backplate 308, the outer casing 310 and the end-cap 314a. Accordingly, no ligature points are present at any of the exposed surfaces.

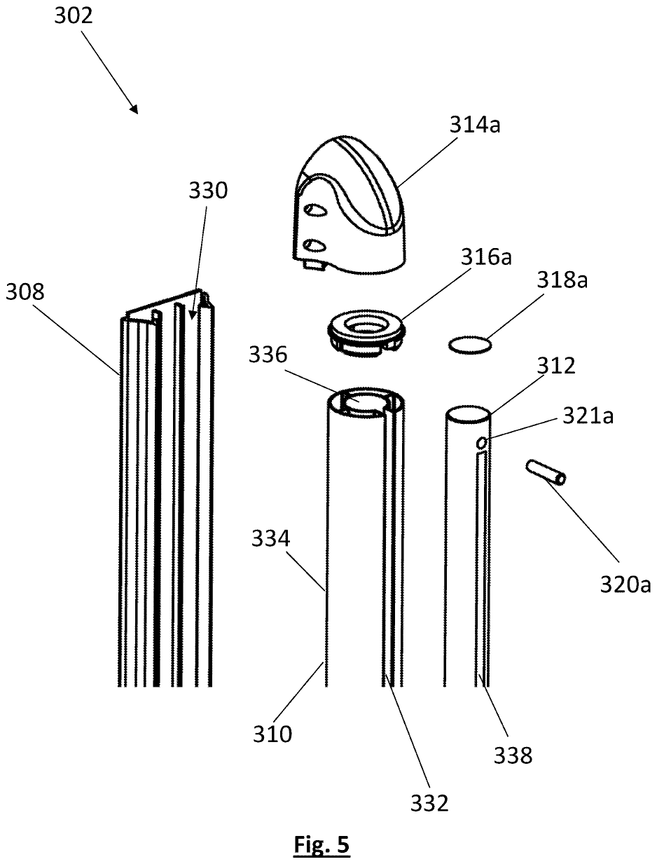

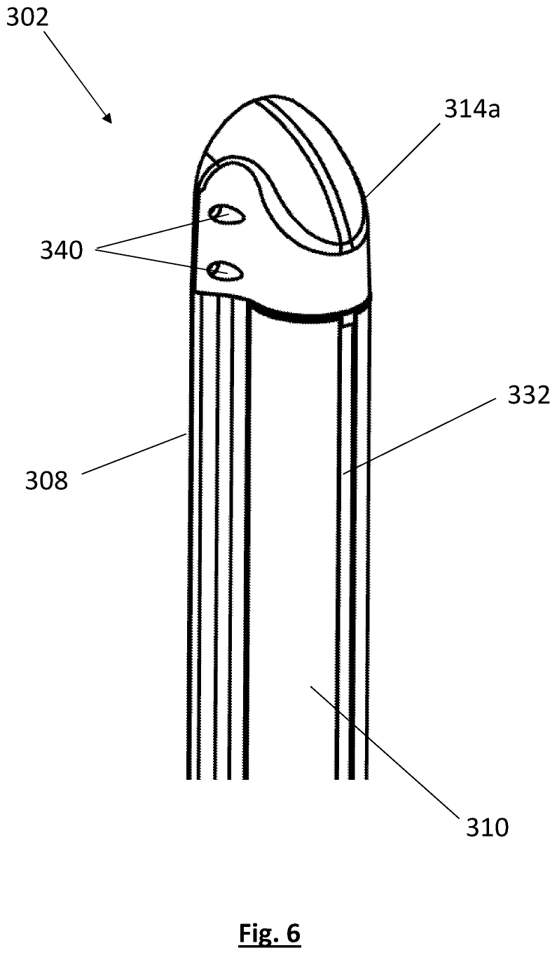

FIG. 6 shows an assembled view of the of the first (top) end of the hinge assembly 302 from FIG. 5. As described above, the only exposed components are the backplate 308, the outer casing 310, and the end-cap 314a. They collectively form a substantially continuous and rigid outer surfaces. Gaps between the components are minimal. The longitudinal opening 332 can be seen. In use, the door leaf 304 would be inserted into this opening. As shown, the end-cap 314a may be secured to a wall or door frame by screws at apertures 340. The backplate may similarly be attached to the wall or door frame by screws (not shown here).

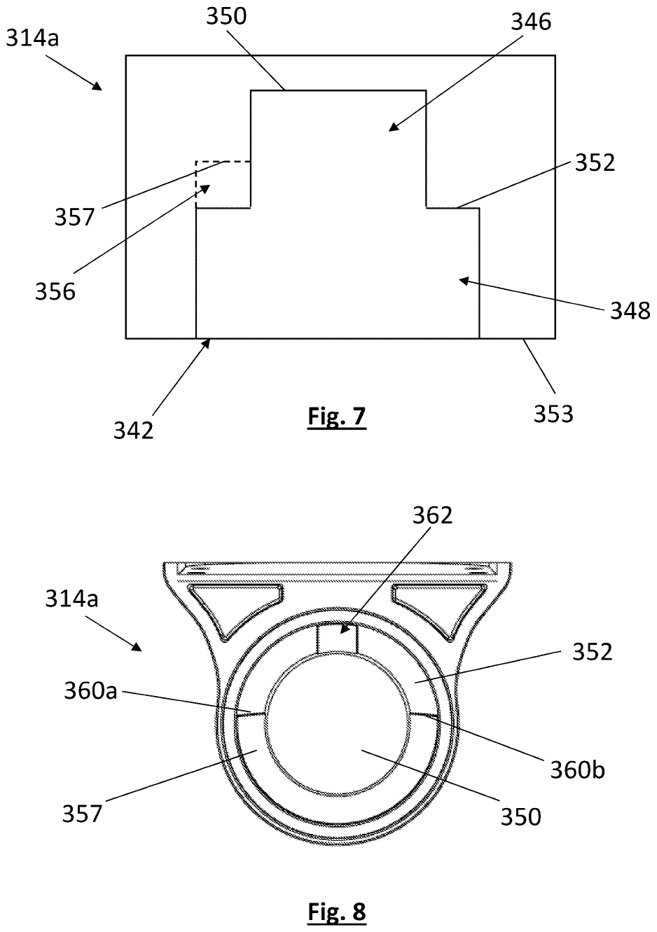

FIG. 7 shows a schematic illustration of the internal structure of the end-cap 314a, in a side-view. The end-cap 314a includes an opening 342 into which the hinge pin 312 and the annular bearing 316a are inserted when the hinge assembly 302 is assembled. At a base of the end-cap 314a is a first cylindrical recess 346 into which the hinge pin 312 is inserted when assembled. The diameter of the first cylindrical recess 346 is equal to, or slightly larger than, the diameter of the hinge pin 312. Therefore, the hinge pin 312 is able to rotate in the end-cap 314a. The end-cap 314a also includes a second, shallower, cylindrical recess 348. The second cylindrical recess 348 receives the annular bearing 316a when the hinge assembly 302 is assembled. The second cylindrical recess 348 is concentric with the first cylindrical recess 346. Accordingly, each of the hinge pin 312 and the outer casing 310 rotate relative to the end-cap 314a. The friction-reducing disc 318a engages the first (circular) end-surface 350. The annular bearing 316a engages the second (annular) end-surface 352. When assembled as described above, the end of the outer casing abuts the outer end-surface 353.

Also shown in FIG. 7 is a circumferential track 356, having a circumferential end-surface 357 which extends only part way around the circumference of the second cylindrical recess 348. The circumferential end-surface is recessed from the second (annular) end-surface 352. That is, the circumferential end-surface is deeper into the end-cap 314a than the second end-surface 352, but shallower in the end-cap 314a than the first end-surface 350. The circumferential track 356 receives the pin 320a. The circumferential end-surface 357 is shown more clearly in FIG. 8, and will be described below.

FIG. 8 shows an underside view of end-cap 314a. End cap is typically aluminium, for example a milled aluminium piece. The circumferential end-surface 357 can be clearly seen. As shown, the circumferential end-surface extends only part way around the second end-surface 352. In the shown example, it extends between 180° and 190° around the circumference of the second end-surface. It terminates at each end at a respective abutment 360a, 360b. The abutments 360a, 360b are configured to provide a stop for engaging the pin 320a to thereby restrict rotational motion of the hinge pin 312 relative to the end-cap.

The end-cap 314a may also include a storage indent 362 for receiving the pin 320a when the hinge assembly is in a storage configuration. In this configuration, the elongate opening 332 and the elongate groove 338 will face towards the backplate 308, such that they are not open to the room. Accordingly, whenever the door leaf 304 is detached from the hinge assembly 302, the hinge assembly can be placed in the storage state to conceal the potential ligature point which would otherwise be provided by the exposed elongate opening 332/groove 338.

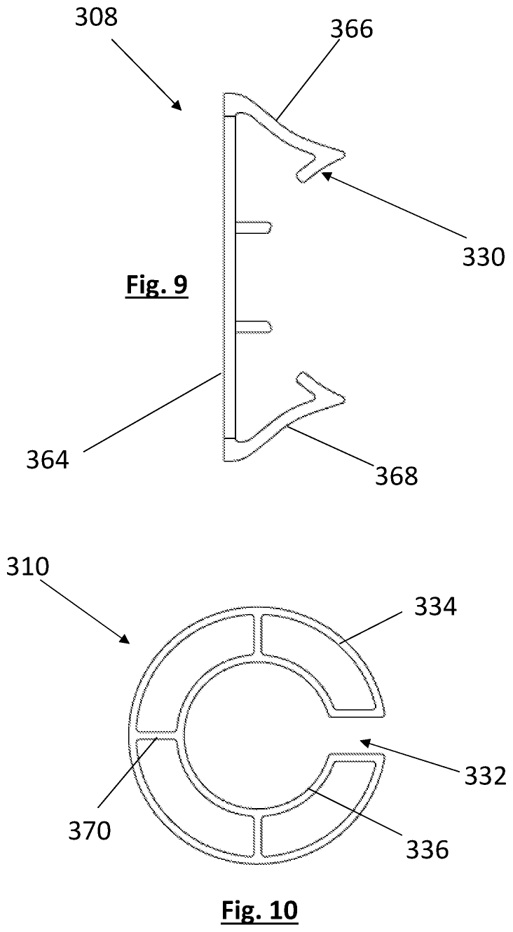

FIG. 9 shows an end-view of the backplate 308. The backplate is typically aluminium, for example an extruded aluminium piece. The backplate 308 includes a rear attachment surface 364 for attachment to a wall or door frame, a first shoulder surface 366, and a second shoulder surface 368, and a channel 330. The channel 330 has a curvature which matches that of the outer surface 334 of the outer casing 310, such that the outer casing 310 intimately engages the channel with substantially no gaps therebetween. Shoulder surfaces 366 and 368 slope away from the channel so that the backplate 308 and outer casing 310 collectively provide an exposed surface of the hinge assembly 302 which is free of ligature points.

FIG. 10 shows an end-view of the outer casing 310. Outer casing 310 is typically aluminium, for example an extruded aluminium piece. The outer casing is hollow, including a cylindrical inner wall 336 and a cylindrical outer wall 334. The inner and outer walls are attached by a number of webs 370 which are evenly spaced around the circumference of the inner wall 336. The elongate opening 332, which extends the length of the outer casing 310, is also shown. The outer casing is typically made from aluminium, and may be an extruded aluminium piece.

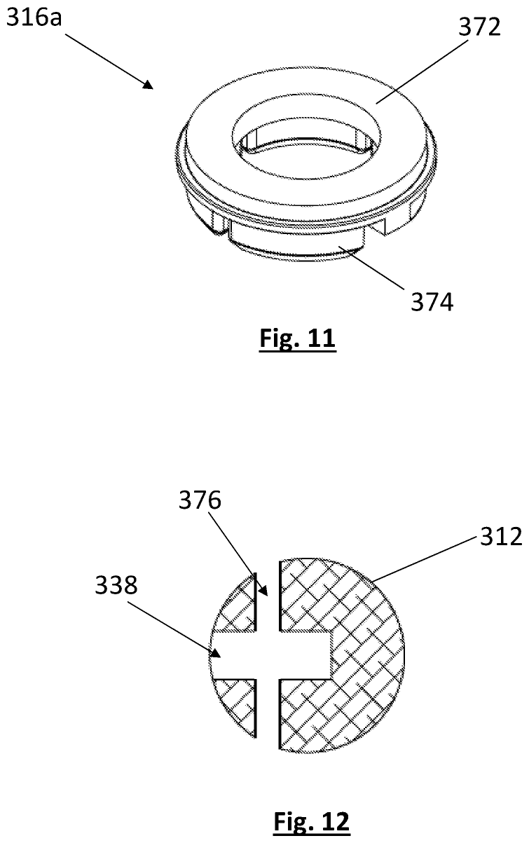

FIG. 11 shows a perspective view of the annular bearing 316a. The inner diameter of the annular bearing 316a matches the diameter of the hinge pin 312. The annular bearing surface 372 of the annular bearing is sized to fit within the second cylindrical recess 348. At least the annular bearing surface 372 may comprise a low friction material, for example a PTFE coating (such as a Teflon coating), or a nylon coating, or a ceramic coating. In some examples, the entire annular bearing 316a may comprise a low-friction material, for example nylon. The underside 374 of the annular bearing 316a may be sized for a friction fit with the end of the outer casing 310.

FIG. 12 shows a cross-sectional view of the hinge pin 312. The hinge pin is typically a metal pin, for example a steel pin. The elongate groove 338 is clearly shown as extending part way into the hinge pin 312. Also shown is a transverse opening 376 through which a screw is inserted when assembled, to maintain the door leaf 304 in place.

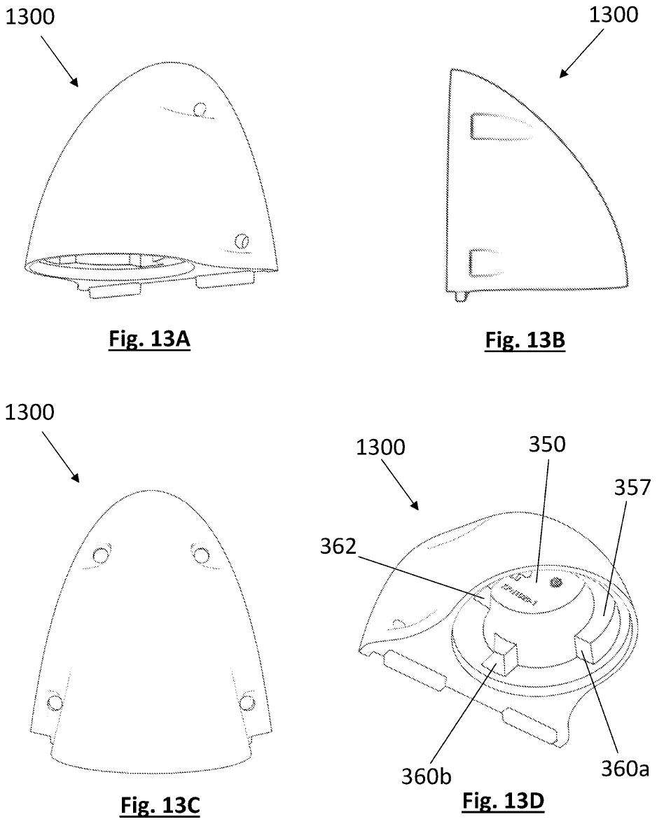

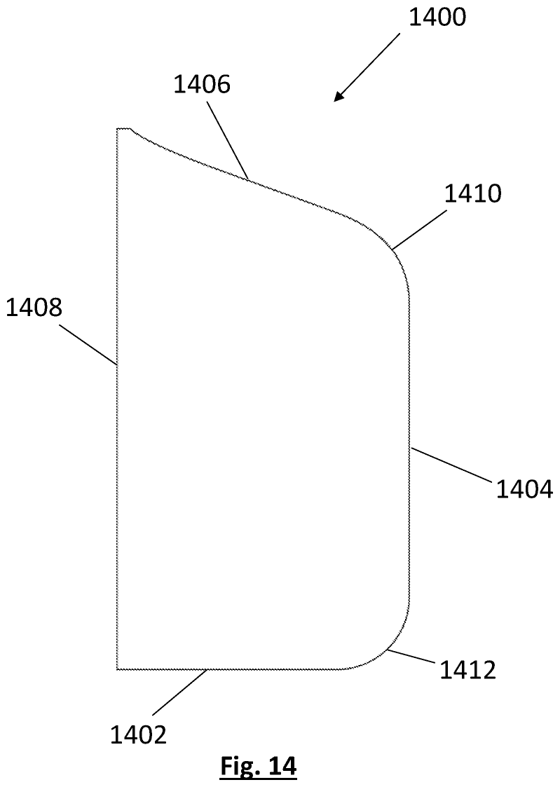

FIGS. 13A-13D show various views of a further end-cap 1300 according to the present disclosure. In some examples, the end-caps 314a, 314b of the door system 300 may be replaced with end-caps 1300 according to FIGS. 13A-13D. As shown, the end-caps have a more pronounced curve to their external surface. In particular, they comprise a continuously curved external profile, which may help to further eliminate ligature points. Functionally and structurally, the end-cap 1300 is otherwise the same as end caps 314a, 314b.

FIG. 13D shows an under-side perspective view of the end-cap 1300. Shown clearly in the under-side perspective view are the recessed circumferential end-surface 357, the recessed storage indent 362, the abutment surfaces 360a, 360b, and the end-surface 350.

FIG. 14 shows an alternative door leaf 1400 for use with the door system 300 of the present disclosure. As shown, the lower edge 1402 of the door leaf 1400 forms a right-angle with respect to the closing edge 1404. The upper edge 1406 is curved and slopes downwards towards the closing edge 1404. Accordingly, the edge 1408 for attachment to the hinge pin 312 is longer than the closing edge 1404. The closing edge corners 1410, 1412 are rounded. The closing edge 1404 is parallel with the edge 1408 for attachment to the hinge pin 312.

It is to be understood that the above description is intended to be illustrative, and not restrictive. Many other implementations will be apparent to those of skill in the art upon reading and understanding the above description. Although the present disclosure has been described with reference to a specific example implementation, it will be recognized that the disclosure is not limited to the implementations described, but can be practiced with modification and alteration insofar as such modification(s) and alteration(s) remain within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A hinge assembly comprising:
an elongate hinge pin for attachment to a door leaf;
an end-cap for attachment to a wall or door frame, wherein an end of the hinge pin is rotatably received within the end-cap; and
an elongate outer casing surrounding the hinge pin, wherein the outer casing has an inner surface which receives the hinge pin, and a cylindrical outer surface which is radially spaced from the inner surface.

2. The hinge assembly of claim 1, further comprising:
an elongate backplate for attachment to a wall or door frame, the backplate having an elongate channel, wherein the end-cap abuts an end of the backplate, and wherein the outer casing is received by the channel,
optionally wherein the channel has a width which spans no more than a 180° arc of the outer casing.

3. (canceled)

4. The hinge assembly according to claim 2,
wherein the channel has a curvature which substantially matches that of the outer casing.

5. The hinge assembly according to claim 2, wherein at least one of:
the backplate comprises two shoulder surfaces, each of which slopes away from a respective outer edge of the channel, and wherein the outer casing abuts an intersection between each shoulder and the channel; or
the backplate is substantially the same length as the outer casing.

6. (canceled)

7. The hinge assembly according to claim 1,
wherein an outer diameter of the end-cap is substantially equal to the outer diameter of the outer casing.

8. The hinge assembly according to claim 1,
wherein the hinge pin comprises a solid metal rod, for example a solid aluminium rod.

9. The hinge assembly according to claim 1,
wherein an elongate groove is formed along the hinge pin, the elongate groove arranged for receiving a door leaf.

10. The hinge assembly of claim 9, wherein at least one of:
the outer diameter of the outer casing is at least 5 times the width of the groove formed in the hinge pin, for example at least 6 times the width of the groove formed in the hinge pin, for example at least 7 times the width of the groove formed in the hinge pin; or
the outer casing comprises an elongate opening aligned with the elongate groove of the hinge pin.

11. The hinge assembly of claim 1,
wherein the outer casing is configured to co-rotate with the hinge pin.

12. (canceled)

13. The hinge assembly of claim 1,
wherein the outer casing comprises an inner cylindrical wall for receiving the hinge pin, and an outer cylindrical wall which is radially spaced from the inner cylindrical wall, optionally
wherein the outer cylindrical wall is spaced from the inner cylindrical wall by at least one web.

14. (canceled)

15. The hinge assembly according to claim 1,
wherein the end of the hinge pin protrudes from a corresponding end of the outer casing.

16. The hinge assembly according to claim 1, further comprising:
a friction-reducing disc attached to the end of the hinge pin, wherein the friction-reducing disc has a lower coefficient of friction than the surface of the hinge pin.

17. The hinge assembly according to claim 1, further comprising:
an annular bearing attached to an end of the outer casing, the annular bearing being received within the end-cap to facilitate rotation of the outer casing relative to the end-cap.

18. The hinge assembly according to claim 1, wherein the end of the hinge pin is received within the end-cap.

19. The hinge assembly of claim 1, further comprising:
a protrusion laterally extending from the end of the hinge pin, wherein the end-cap comprises an circumferential track within which the protrusion is received, and wherein each end of the circumferential track comprises an abutment arranged to engage the protrusion to thereby restrict the rotational motion of the hinge pin.

20. The hinge assembly of claim 19,
wherein an elongate groove is formed along the hinge pin, the elongate groove arranged for receiving a door leaf,
wherein the protrusion is adjacent an end of the groove and is in-line with the groove.

21. The hinge assembly of claim 19, further comprising:
an annular bearing attached to an end of the outer casing, the annular bearing being received within the end-cap to facilitate rotation of the outer casing relative to the end-cap,
wherein the protrusion is adjacent to the annular bearing.

22. The hinge assembly of claim 1, comprising:
a first end-cap at a first end of the backplate, wherein a first end of the hinge pin is rotatably received within the first end-cap; and a second end-cap at a second and of the backplate, wherein a second end of the hinge pin is rotatably received within the second end-cap.

23. A door system, the door system comprising:
a hinge assembly according to claim 1, and a door leaf attached to the hinge pin.

24. The door system of claim 23,
wherein an elongate groove is formed along the hinge pin, the elongate groove arranged for receiving a door leaf,
wherein the door leaf is received within the elongate groove of the hinge pin.
